(19) United States
(12) Patent Application Publication
(10) Pub. No.: US 2025/0058441 A1
(43) Pub. Date: Feb. 20, 2025

(54) TOOL FOR PEELING A WEIGHT FROM A RIM

(71) Applicant: U-CAR INDUSTRY CO., LTD., Taichung (TW)

(72) Inventors: JUNG-HUA CHUANG, TAICHUNG (TW); CHAO-CHING TSENG, TAICHUNG (TW)

(21) Appl. No.: 18/233,889

(22) Filed: Aug. 15, 2023

(51) Int. Cl. B25B 27/00

(52) U.S. Cl. CPC B25B 27/0078

(57) ABSTRACT

A tool is devised to peel a weight from a rim of a wheel. The peeling tool includes a handle and a string supported on the handle. The string is loaded with an adequate tension so that the handle is maneuverable to use the string to peel the weight from the rim.

### BACKGROUND OF INVENTION

### 1. Field of Invention

The present invention relates to a rim of a wheel and, more particularly, to a tool for peeling a weight from a rim.

### 2. Related Prior Art

A wheel includes a rim for support a tire. The rim includes a tubular portion, two annular portions extending from an external face of the tubular portion, a hub, and spokes formed between the hub and the tubular portion. The annular portions of the rim are operable to engage with two beads of the tire. The hub includes a central aperture for receiving an axle of a vehicle in operation.

The wheel, which consists of the rim and the tire, is not perfectly symmetric about the center of the central aperture in shape. The rim and the tire are not homogenous in weight. Hence, the wheel tends to vibrate in rotation, i.e., the vehicle tends to be unstable in operation. A driver and/or passenger feel uncomfortable in the vehicle. To solve this problem, a weight or more can be attached to the rim to render the center of weight of the wheel as near the center of the central aperture as possible.

A weight is attached to the rim by a hook or a sticker. The hook engages with one of the annular portions of the rim. The sticker sticks to the internal face of the rim.

A weight formed with a hook can be removed from the annular portion of the rim with a pair of pliers disclosed in U.S. Pat. No. 9,044,844. The pair of pliers includes two grips 15 and 25, a hook 18 and a protective cover 40. In operation, the grips 15 and 25 are opened to allow a weight 34 to be located between the hook 18 and the protective cover 40. Then, the grips 15 and 25 are pivoted toward each other so that the hook 18 and the protective cover 40 bite the weight 34. Finally, the pair of pliers is pivoted as the protective cover 40 is located against the rim, thereby removing the weight 34 from the rim.

A weight 56 provided with a sticker can be removed from the internal face of the rim with a pair of pliers disclosed in Taiwanese Patent No. M505385. The pair of pliers includes two grips 52 and two jaws 26 and 36. In operation, the grips 52 are opened to allow the weight 56 to be located between the jaws 26 and 36. Then, the grips 52 are pivoted toward each other to bring the jaws 26 and 36 to each other. Thus, the pair of pliers pinches and removes bit the weight 56 from the internal face of the rim.

The present invention is therefore intended to obviate or at least alleviate the problems encountered in the prior art.

### SUMMARY OF INVENTION

It is the primary objective of the present invention to provide a tool for peeling a weight from a rim of a wheel without risks of damaging the rim.

To achieve the foregoing objective, the peeling tool includes a handle and a string supported on the handle. The string is loaded with an adequate tension so that the handle is maneuverable to use the string to peel the weight from the rim.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a peeling tool according to the first embodiment of the present invention;

FIG. 2 is another perspective view of the peeling tool shown in FIG. 1;

FIG. 3 is a perspective view of a rim and the peeling tool shown in FIGS. 1 and 2;

FIG. 4 is an enlarged view of the rim and the peeling tool depicted in FIG. 3;

FIGS. 5 and 6 are cross-sectional views of fasteners for fastening a string to a handle of the peeling tool shown in FIG. 4;

FIG. 7 is a side view of a peeling tool according to the second embodiment of the present invention; and

FIG. 8 is a side view of a peeling tool according to the third embodiment of the present invention.

### DETAILED DESCRIPTION OF EMBODIMENTS

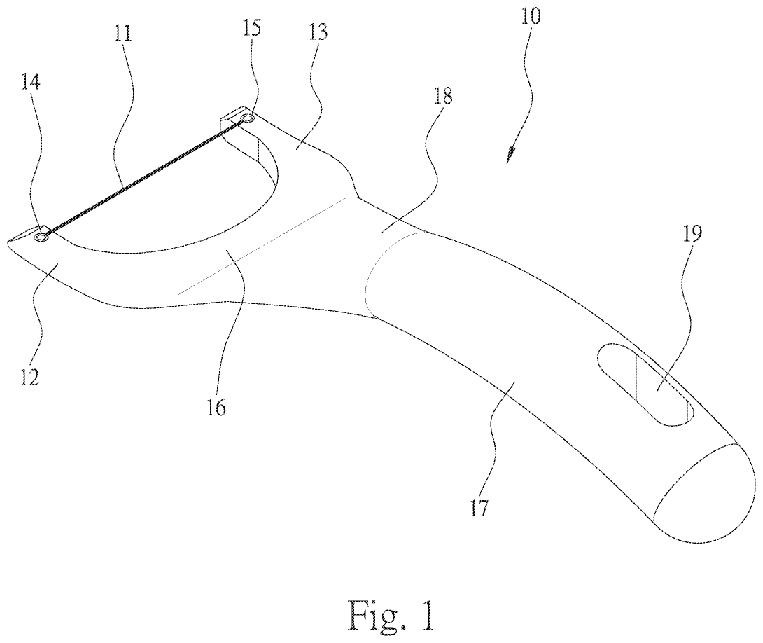

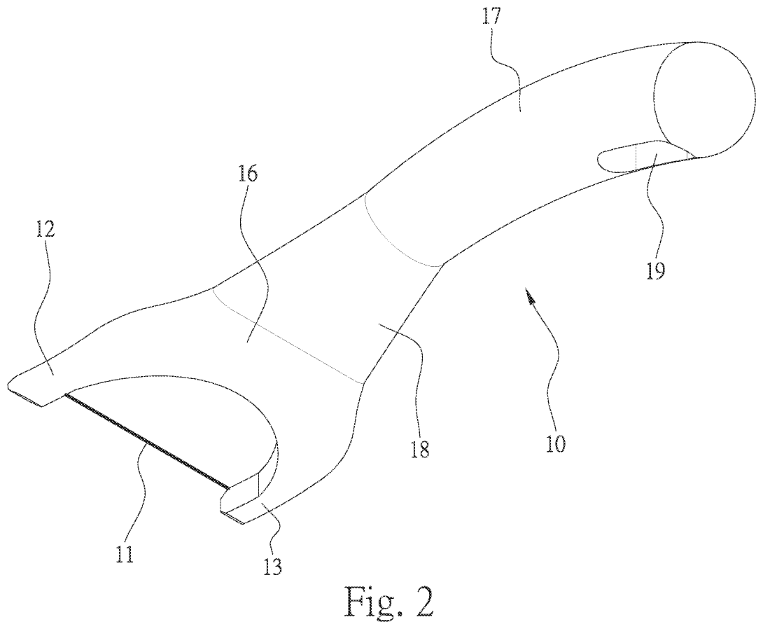

Referring to FIGS. 1 and 2, a peeling tool 10 includes a string 11 supported on a handle according to a first embodiment of the present invention. The handle includes a bow 16, a grip 17 and a transient portion 18 formed between the bow 16 and the grip 17. The bow 16, the grip 17 and the transient portion 18 are made in one piece.

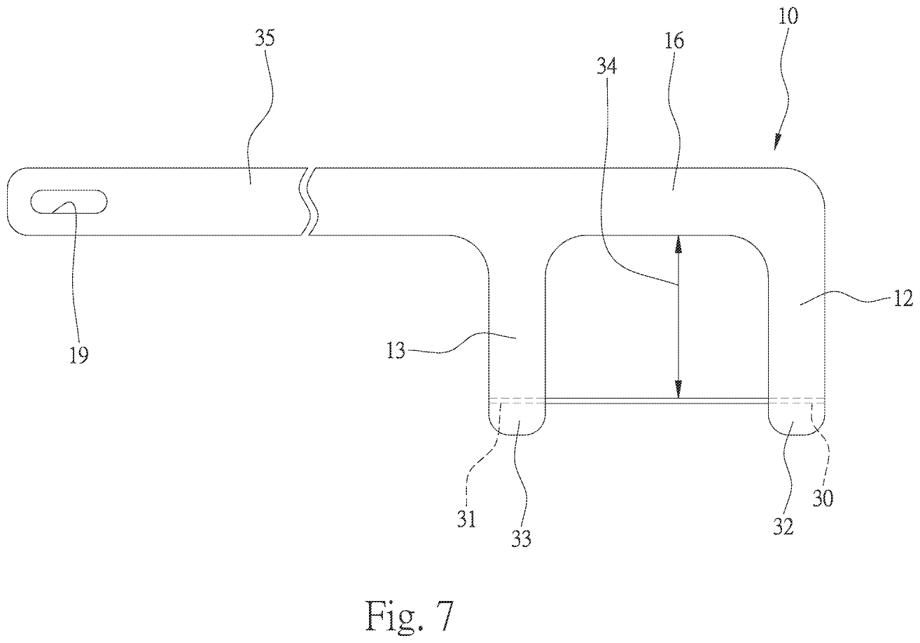

The bow 16 includes an intermediate portion formed between two branches 12 and 13. Two ends of the string 11 are connected to the branches 12 and 13 by two fasteners 14 and 15. There is a distance 34 (FIG. 7) of a middle point of the string 11 from a middle point of the intermediate portion of the bow 16.

The grip 17 extends in perpendicular to the intermediate portion of the bow 16. The grip 17 includes an aperture or slot 19. The aperture 19 allows the peeling tool 10 to be hung on a hook or a nail attached to a wall.

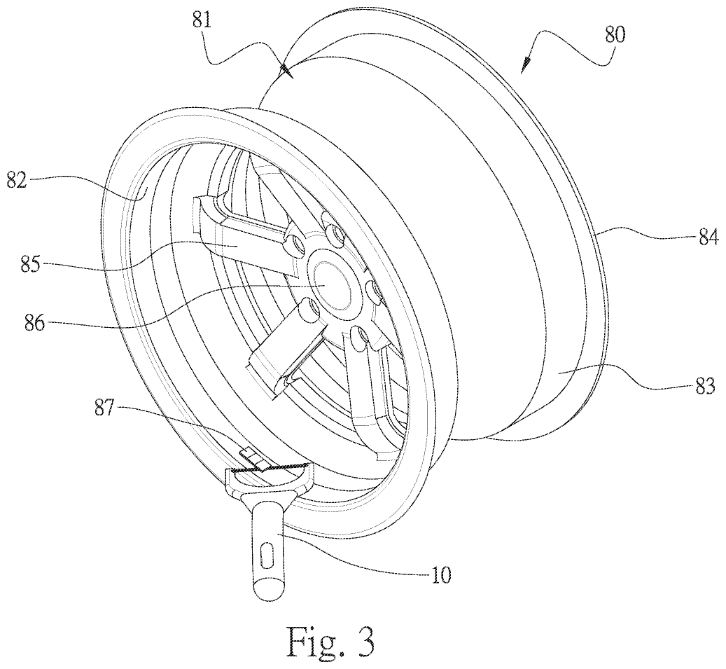

Referring to FIG. 3, a wheel 80 includes tire (not shown) and a rim 81 for support the tire. The rim 81 includes a tubular portion, two annular portions 84 extending from an external face 83 of the tubular portion, a hub (not numbered), and spokes 85 formed between the hub and the tubular portion. The annular portions 84 of the rim 81 are operable to engage with two beads of the tire. The hub includes a central aperture 86. The hub is attached to an axle of a vehicle in operation.

After a tire is supported on the rim 81, a sticker 88 is used to stick a weight 87 to an internal face 82 of the rim 81 to locate the center of weight of the wheel at the center of the central aperture 86. After the tire is replaced with a new tire, the peeling tool 10 is operable to remove the weight 87 from the internal face 82 of the rim 81 to allow another weight to be attached to the rim 81.

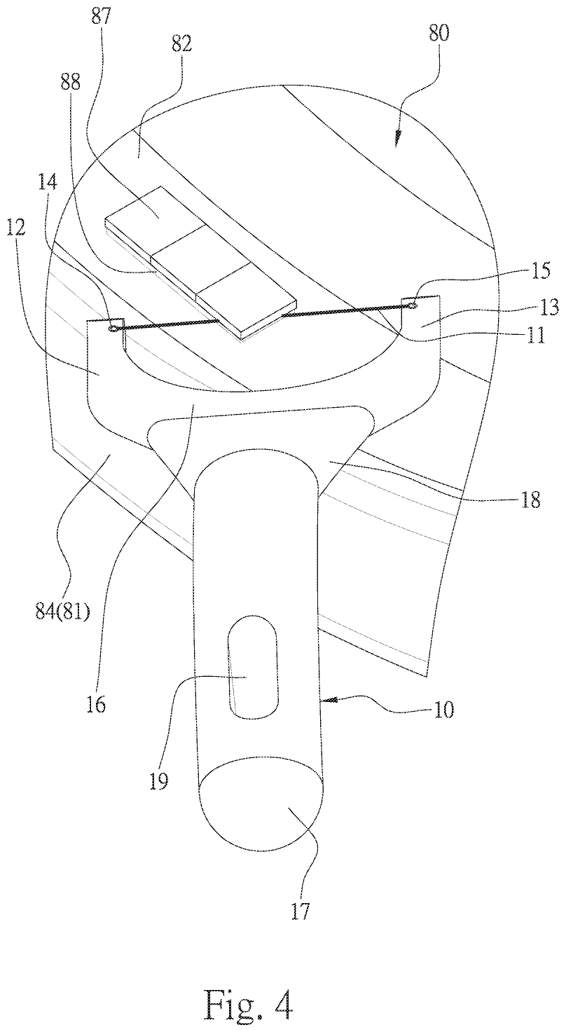

Referring to FIG. 4, the string 11 is loaded with adequate tension so that it is operable like a blade to remove the sticker 88, which is thing and sticky, from the internal face 82 of the rim 81. Unlike a blade, the string 11 does not damage the rim 81.

The pair of pliers discussed in Related Prior Art is used to pinch and remove a weight from a rim. However, the pair of pliers might damage the rim. The string 11 of the peeling tool 10 of the present invention is used to peel the weight 87 from the rim 81. Advantageously, the string 11 does not damage the rim 81.

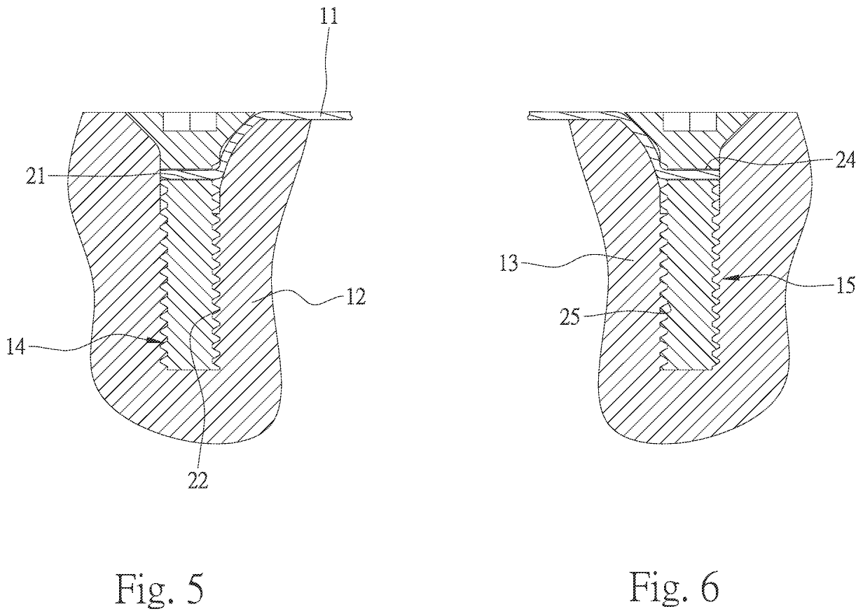

Referring to FIG. 5, the fastener 14 is preferably a screw inserted in a screw hole 22 made in the branch 12. The string 11 includes a first end inserted in a passageway 21 made in the screw 14. The first end of the string 11 is secured to the branch 12 by the screw 14.

Referring to FIG. 6, the fastener 15 is preferably a screw inserted in a screw hole 25 made in the branch 13. The string 11 includes a second end inserted in a passageway 24 made in the screw 15. The second end of the string 11 is secured to the branch 13 by the screw 15.

By tightening the screw 14 or 15 in the screw hole 22 or 25, the tension in the string 11 is increased. By slackening the screw 14 or 15 in the screw hole 22 or 25, the tension in the string 11 is reduced.

Referring to FIG. 7, there is a peeling tool 10 according to a second embodiment of the present invention. The second embodiment is like the first embodiment except for several things. Firstly, a grip 35 is used instead of the grip 17. The grip 35 extends in line with the intermediate portion of the bow 16.

Secondly, an aperture 30 is transversely made in a free end 32 of the branch 12 and an aperture 31 is transversely made in a free end 33 of the branch 13. An end of the string 11 is fitted in the aperture 30 and another end of the string 11 is fitted in the aperture 31.

Thirdly, the screws 14 and 15 are saved. Hence, the tension in the string 11 is not adjustable.

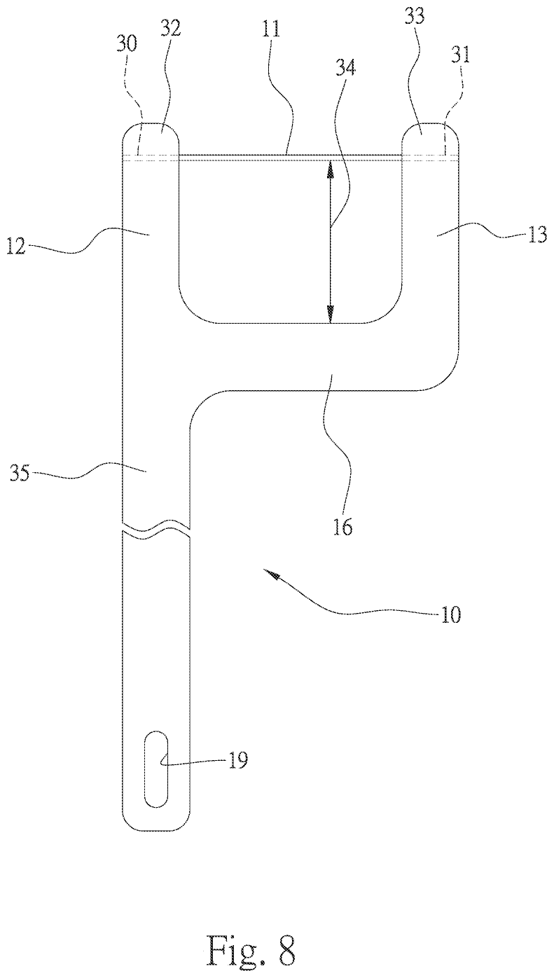

Referring to FIG. 8, there is a peeling tool 10 according to a third embodiment of the present invention. The third embodiment is like the second embodiment except for that the grip 35 extends in line with the branch 12.

The present invention has been described via the illustration of the embodiments. Those skilled in the art can derive variations from the embodiments without departing from the scope of the present invention. Therefore, the embodiments shall not limit the scope of the present invention defined in the claims.

1. A tool for peeling a weight from a rim of a wheel comprising a handle and a string supported on the handle, wherein the string is loaded with an adequate tension so that the handle is maneuverable to use the string to peel the weight from the rim.

2. The tool according to claim 1, wherein the handle comprises a grip and a bow formed at an end of the grip, wherein the bow comprises two branches, wherein the string comprises two ends connected to the branches so that a middle point of the string is at a distance from a middle point of the bow.

3. The tool according to claim 2, comprising two fasteners for connecting the ends of the string to the branches.

4. The tool according to claim 3, wherein each of the fasteners comprises a screw hole made in a corresponding one of the branches and a screw inserted in the screw hole to hold a corresponding one of the ends of the string.

5. The tool according to claim 2, wherein each of the branches comprises an aperture for receiving a corresponding one of the ends of the string.

6. The tool according to claim 2, wherein the grip transversely extends from one of the branches.

7. The tool according to claim 2, wherein the grip extends in-line from one of the branches.

8. The tool according to claim 2, wherein the grip extends from a middle point of the bow.

9. The tool according to claim 8, wherein the grip extends in parallel to the branches.

10. The tool according to claim 8, comprising a transient portion formed between the grip and the bow.
